(19) United States
(12) Patent Application Publication
(10) Pub. No.: US 2006/0190324 A1
(43) Pub. Date: Aug. 24, 2006

(54) Method for providing reduced cost imaging to customers

(75) Inventors: Christopher A. Adkins, Lexington, KY (US); Timothy L. Strunk, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/065,197

(22) Filed: Feb. 24, 2005

(51) Int. Cl. G06Q 30/00

(52) U.S. Cl. 705/14

(57) ABSTRACT

A method for reducing a cost of imaging to a customer includes determining a rate of consumption of imaging substance from a supply item; and, based on the rate of consumption, offering to the customer an imaging reward.

### BACKGROUND OF THE INVENTION

1. Field of the Invention

The present invention relates to imaging, and, more particularly, to providing reduced cost imaging to customers, such as high usage customers.

2. Description of the Related Art

Incentive initiatives, e.g., coupons and rebates, have long been used to attract consumers to purchase certain products. For example, supply items used in imaging with printers and copiers have been subject to such coupon and rebate programs. Supply items differ from many products, however, in that they are purchased on a recurring basis. For high usage customers, the recurrence may be a matter of weeks, or in some cases a few days. However, traditional coupon and rebate programs may not adequately reward high usage customers, such as for example, due to quantity limitations for the program.

### SUMMARY OF THE INVENTION

The present invention relates to a method for providing reduced cost imaging to customers, such as for example, high usage customers.

The present invention, in one exemplary embodiment, is directed to a method for reducing a cost of imaging to a customer, including determining a rate of consumption of imaging substance from a supply item; and, based on the rate of consumption, offering to the customer an imaging reward.

The present invention, in another embodiment, is directed to a supply item for use in an imaging apparatus, the supply item being associated with memory for storing information upon which a rate of consumption of imaging substance from the supply item can be determined, wherein at least one of a cost and an amount of imaging substance associated with an imaging reward is based on the rate of consumption.

The present invention, in another embodiment, is directed to a method for reducing a cost of imaging to a customer, including determining a rate of consumption of imaging substance from a supply item during a current license, wherein an amount of the imaging substance in the supply item is more than will be consumed during the current license; and, based on the rate of consumption during the current license, offering to the customer a new license for at least a portion of a remainder of the amount of imaging substance.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an embodiment of a system that implements the present invention.

FIGS. 2A and 2B combine to form a general flowchart representing a method for reducing a cost of imaging for a customer, such as a high usage customer.

FIGS. 3A and 3B combine to form a general flowchart depicting an embodiment of a security method wherein the imaging apparatus contains the license.

FIGS. 4A and 4B combine to form a flowchart depicting an embodiment of a security method wherein the supply item contains the license.

FIG. 5 is a flowchart depicting another embodiment of a security method wherein the supply item contains the license.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE EXEMPLARY EMBODIMENTS

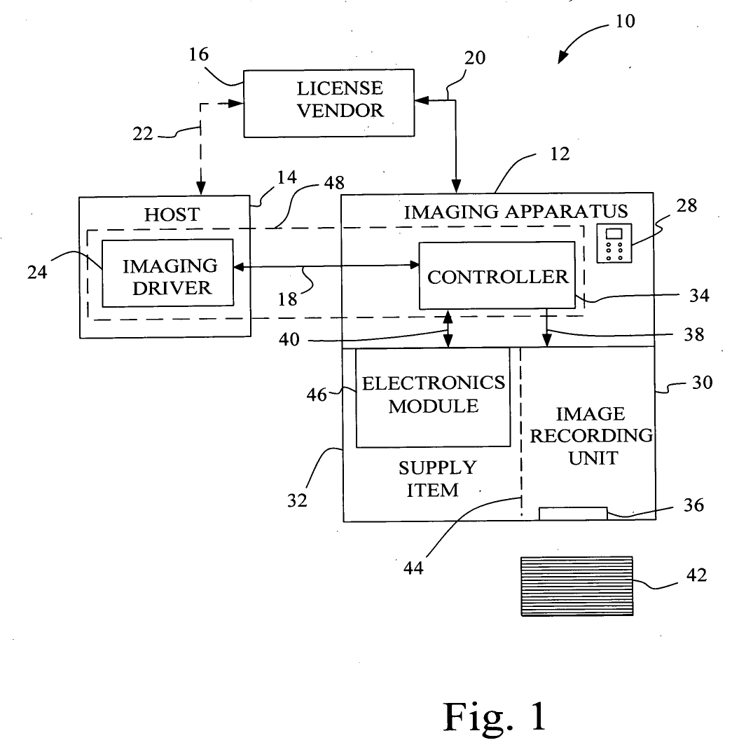

Referring now to the drawings and particularly to FIG. 1, there is shown a diagrammatic depiction of an imaging system 10 embodying the present invention. Imaging system 10 may include an imaging apparatus 12, a host 14 (optional), and a license vendor 16. Imaging apparatus 12 communicates with host 14 via a communications link 18. License vendor 16 may communicate with one, or both, of imaging apparatus 12 and host 14. For example, license vendor 16 may communicate with imaging apparatus 12 via communications link 20 and/or may communicate with host 14 via communications link 22, which is optional as indicated by the dashed line.

As used herein, the term “communications link” is used to generally refer to structure that facilitates electronic communication between two or more components, and may operate using wired or wireless technology.

Communications link 18 may be established, for example, by a direct cable connection, wireless connection or by a network connection such as for example an Ethernet local area network (LAN). Imaging apparatus 12 may communicate with host 14 via a standard communication protocol, such as for example, universal serial bus (USB) or Ethernet. Communication links 20, 22 may be established, for example, by a direct cable connection, wireless connection or by a network connection, such as a LAN, wide area network or Internet connection.

In embodiments including host 14, host 14 may be, for example, a personal computer including a display monitor, an input device (e.g., keyboard), a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 24 for imaging apparatus 12. Imaging driver 24 serves to facilitate communications between imaging apparatus 12, and optionally, may serve to facilitate communications with license vendor 16. In addition, imaging driver 24 serves in the traditional roll of providing formatted print data to imaging apparatus 12.

Imaging apparatus 12 may include an ink jet print engine, or an electrophotographic print engine. Further, imaging apparatus 12 may be used as a standalone unit that is not communicatively linked to a host, such as host 14. For example, imaging apparatus 12 may take the form of a multifunction machine, e.g., an all-in-one (AIO) device, which includes standalone copying and facsimile capabilities, in addition to optionally serving as a printer when attached to a host, such as host 14.

In one embodiment, the stand-alone features of imaging apparatus 12 includes connectivity and processing capability sufficient to implement the various methods of the invention in the absence of host 14. In some implementations, for example, imaging apparatus 12 may communicate directly with license vendor 16 via communication link 20, such as for example, a telephone line connection.

Imaging apparatus 12 may include, for example, a user interface 28, an image recording unit 30, a supply item 32 and a controller 34, which may be in the form of one or more Application Specific Integrated Circuits (ASIC). Controller 34 communicates with image recording unit 30 via a communications link 38. Controller 34 communicates with supply item 32 via a communications link 40.

In the context of the examples for imaging apparatus 12 given above, image recording unit 30 may be, for example, an ink jet printhead unit or an electrophotographic printing unit, and includes an imaging head 36 used for forming an image on a substrate 42, such as a sheet of print media, e.g., paper, transparency, fabric, etc., or a photoconductive member. For convenience, each type of substrate 42 will be referred to by the element number 42, for example, sheet(s) of print media 42.

Supply item 32 can be, for example, an ink supply tank, an ink jet cartridge, a toner tank, or an electrophotographic process (EP) cartridge, each of which containing a supply of an imaging substance, such as for example ink or toner, that is consumed during an imaging process. Imaging apparatus 12 uses the imaging substance contained in supply item 32 to form an image on the sheet of print media 42. Those skilled in the art will recognize that image recording unit 30 and supply item 32 may be formed as individual discrete units, or may be combined in an integral unit, these options being depicted by dashed line 44. Thus, as used herein, the term “supply item” is intended to refer to either possibility.

Supply item 32 can be subject to a license as to the amount of imaging substance contained therein that is available for use. The license may be referenced, for example, by license information, which may include a license identification and a licensed amount of usage. The initial supply amount (fill level) of imaging substance contained in supply item 32 can be greater than the initial licensed amount of usage of the imaging substance in supply item 32. For example, in one implementation of the invention, the initial supply amount of the imaging substance contained in supply item 32 may be, for example, at least two times greater than the licensed amount. It is important to note, however, that while the initial amount of imaging substance supplied with imaging apparatus 12 and/or supply item 32 is sufficient to accommodate both the initial license and one or more license renewals, the consumer has been required to pay only for the licensed amount at the time of the original supply item acquisition.

The licensed amount of usage of supply item 32 may be represented in a variety of forms, such as for example: the amount of imaging substance consumed from supply item 32; the number of imaging dots formed on print media, such as sheets of print media 42; the percent of image coverage on the printed sheets of media 42; the number of sheets of print media printed by supply item 32; the number of sheets printed by supply item 32 that exceeds a predetermined coverage amount; the number of imaging operations performed by imaging apparatus 12 with supply item 32 installed; and/or an amount of time.

In one embodiment, supply item 32 has mounted thereto an electronics module 46, which includes memory for storing information relating to supply item 32. In some embodiments, electronics module 46 may include a controller ASIC for performing program instructions relating to the licensing of supply item 32. By attaching electronics module 46 to supply item 32, in essence, the information relating to supply item 32, e.g., usage license information associated with supply item 32, can travel with supply item 32 from one imaging apparatus to another. The information relating to supply item 32 may include, for example: a supply item identification number; a fill level, i.e., the initial amount of the imaging substance contained in supply item 32; a type of supply item 32, e.g., monochrome, color, photo, etc.; a usage gauge to maintain a record of usage of supply item 32; and/or usage license information, which may include a license identification and an indication of the licensed amount of usage of supply item 32.

License vendor 16 provides to a consumer access to a new usage license. License vendor 16 may be, for example, a license server, and may facilitate e-commerce transactions. In summary, in the licensing methods of the invention, a usage license is associated with at least one of imaging apparatus 12 and supply item 32, and when the usage of imaging apparatus 12 and/or supply item 32 has reached a predefined usage threshold, the consumer is prompted to acquire a new license from license vendor 16. This predefined usage threshold can, for example, represent a usage amount that is associated with the license being close to expiring, or a usage amount associated with license expiration.

In one embodiment of the invention, for example, license vendor 16 may be an e-commerce server that may be accessed by a customer via on-line communications over the Internet to acquire the new license. The e-commerce server may include a database established for enrolling and monitoring the customer's participation in an imaging rewards program, such as a license, electronic coupon, or rebate program, based on a rate of consumption of imaging substance, also referred to herein as a usage rate. The e-commerce server may be maintained in a database with confirmation electronically transmitted to imaging apparatus 12 or host 14. The acquisition of an additional supply item may be in the form of a renewal of supply item 32. The renewal may be in the form of a replacement for supply item 32, a number of physical replenishments of supply item 32, or, in a licensing implementation, by a virtual replenishment of supply item 32 through a new license, e.g., license renewal(s).

Also shown in FIG. 1 is a license monitoring mechanism 48, which is a functional unit that may reside in either of imaging apparatus 12 or host 14, or may reside in a combination of imaging apparatus 12 and a host 14, these options being depicted by the dashed-line representing license monitoring mechanism 48. For example, license monitoring mechanism 48 may be formed, in whole or in part, in controller 34 of imaging apparatus 12 or imaging driver 24 of host 14. In one embodiment, for example, license monitoring mechanism 48 is resident in the combination of controller 34 of imaging apparatus 12 and imaging driver 24 of host 14. In general, license monitoring mechanism 48 tracks an amount of usage of supply item 32 by imaging apparatus 12, determines whether the amount of usage of supply item 32 by imaging apparatus 12 has reached a usage threshold, and upon reaching the usage threshold, then prompting the consumer to acquire a new license, which may include a renewal of the present license. Where a consumer desires an on-line e-commerce acquisition of the new license, for example, license monitoring mechanism 48 may initiate and establish communications with license vendor 16 for acquiring the new license.

The usage license may be structured to require a combination of a particular imaging device, such as imaging apparatus 12, and a particular supply item, such as supply item 32. Such a combination may be verified by using identification numbers associated with the imaging apparatus and the supply item. Alternatively, the license may be structured such that the license only applies to a particular imaging apparatus or to a particular supply item.

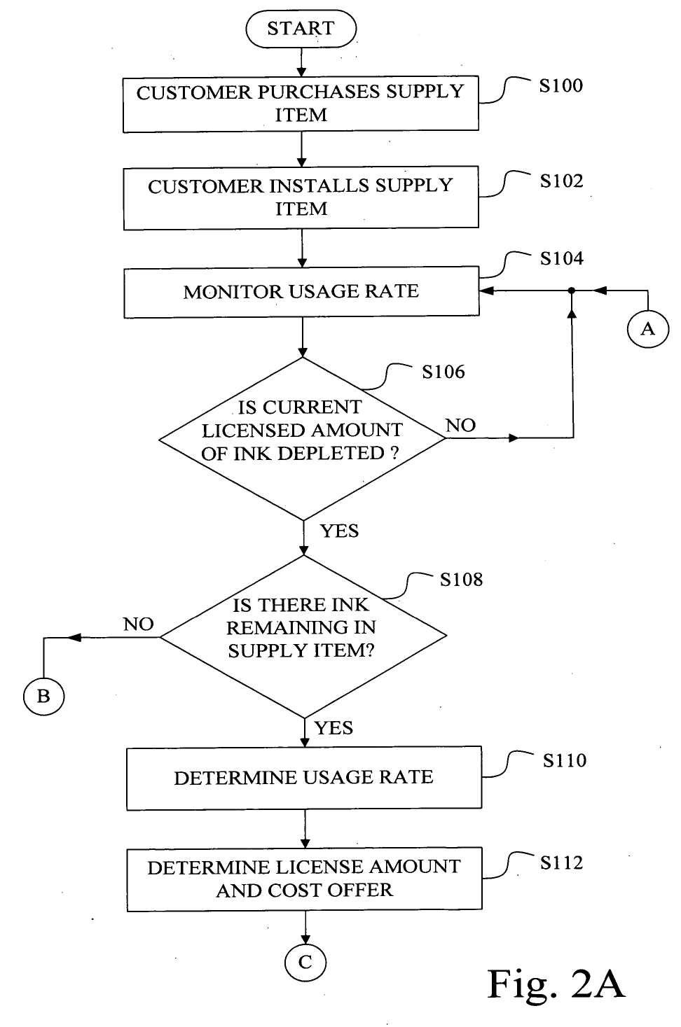

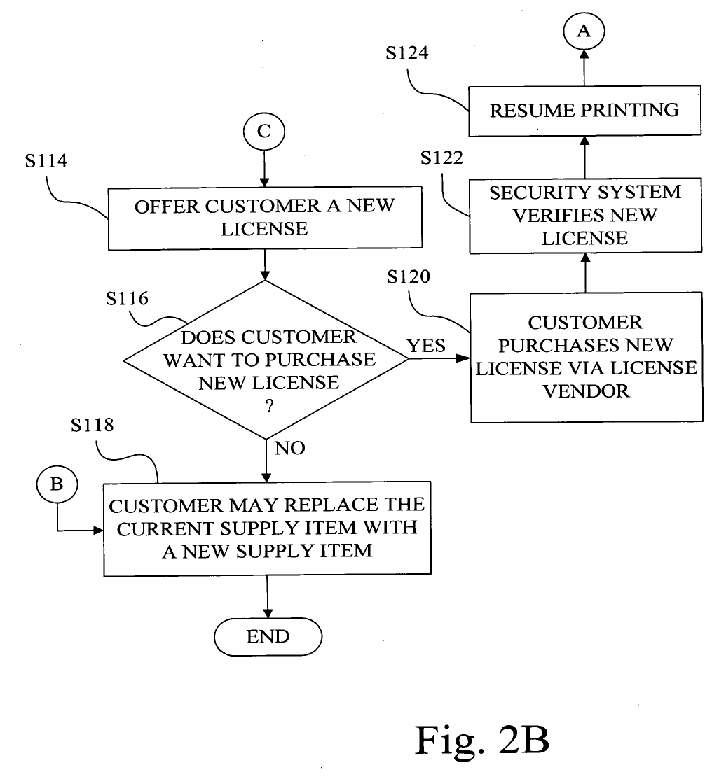

FIGS. 2A and 2B combine to form a general flowchart representing one embodiment of a method for reducing a cost of imaging for a customer, such as a high usage customer.

At step S100, a customer acquires a supply item, e.g., supply item 32, which is subject to a usage license. The usage license may be associated directly with supply item 32 (with license information stored in supply item electronics module 46), or associated indirectly by being associated with imaging apparatus 12. As set forth above, the imaging substance fill level of supply item 32 when new is sufficient to service an initial license, and at least one new license. For example, the initial license may cover a predetermined initial percent of the total imaging substance contained in supply item 32, e.g., 25 percent, and the new license may cover the remainder, or some predetermined portion of the remainder.

At step S102, the customer installs supply item 32 in imaging apparatus 12.

At step S104, a rate of consumption of supply item 32 is monitored. The monitoring may be performed, for example, by license monitoring mechanism 48 of imaging apparatus 12 and/or host 14. The monitoring may be performed continuously, or at a predetermined event, such as for example, when a low level of an imaging substance, such as ink or toner, is identified in supply item 32, or when a predetermined time has expired.

It is contemplated that the rate of consumption may be determined based on a variety of time and usage criteria. For example, the rate of consumption can be based on an amount of time required to use a specified amount of supply item 32; based on an amount of time between acquisitions of the supply items; based on an amount of use of the supply item, e.g., imaging substance volume depleted, during a specified amount of time; based on an amount of the supply item acquired, e.g., imaging substance volume acquired, during a specified amount of time; or, based on a quantity of the supply item, e.g., the number, acquired during a specified amount of time.

At step S106, it is determined whether the amount of imaging substance associated with the current usage license associated with supply item 32 is depleted. This determination may be made, for example, by license monitoring mechanism 48 of imaging apparatus 12 and/or host 14. If the determination at step S106 is NO, then the process returns to monitoring at step S104.

If the determination at step S106 is YES, then a step S108 it is determined whether there is any remaining imaging substance in supply item 32 that may be used to service a new license. The determination may be, for example, a calculation performed by license monitoring mechanism 48 of imaging apparatus 12 and/or host 14. If the determination is NO, for example, then at step S118 the customer simply may replace the current supply item with a new supply item. The process would then begin over at step S100.

If the determination at step S108 is YES, then at step S110 the usage rate during the current license and/or previous license is determined, based on information acquired at step S104. The determination may be, for example, a calculation performed by license monitoring mechanism 48 of imaging apparatus 12 and/or host 14.

At step S112, the amount of imaging substance and associated cost for a new license is determined. The determination may be, for example, a calculation performed by license monitoring mechanism 48 of imaging apparatus 12 and/or host 14. For example, once the initial license has been depleted, the customer may be offered the remaining amount of imaging substance in supply item 32, or some portion thereof, at a price based on the usage rate determined at step S110. Generally, the higher the usage rate becomes, the lower the price of the supply item will become.

In one embodiment, depicted in Table 1, below, the higher the usage rate, the more ink will be offered for the next license and the effective cost per page will decrease.

TABLE 1
Imaging Substance Amount and Cost of Next License Offering

| Time Required | Amount of | | | |
|---|---|---|---|---|
| to Use Initial | Imaging | New | Effective | Expected |
| Licensed | Substance for | License | Per Page | Time to Use |
| Supply | New License | Cost to | Cost to | New License |
| (in Weeks) | (in Pages) | Customer | Customer | (in Weeks) |
| 26 | 150 | $10 | $0.07 | 26 |
| 13 | 300 | $15 | $0.05 | 26 |
| 6 | 600 | $20 | $0.03 | 24 |
| 3 | 900 | $20 | $0.02 | 18 |
| 2 | 1200 | $20 | $0.02 | 16 |

Thus, in this example, imaging apparatus 12 may offer the customer the opportunity to purchase a new (second) license, with the amount and the cost of that second license being based on the rate at which the first license was used, i.e., the usage rate of imaging substance during the previous license(s). The higher usage rate customers will have the option of the highest offering or any of the lower offerings. For instance, from Table 1, a customer with a time to use initial supply of 6 weeks may be presented with an offering of an imaging substance equivalent of 600 pages, as well as options for 300 or 150 pages. However, that same customer will not be given the option of the 900 or 1200 page offerings.

Accordingly, the acquisition cost of the new license associated with supply item 32 remains low, regardless of which usage rate is determined, but customers having higher usage rates will benefit from lower cost per page imaging, thereby further decreasing the total cost of imaging for the higher usage customers.

Another benefit is that the license replenishment rate will remain relatively constant regardless of the usage rate. For example, from the far right column of Table 1, it can be seen that the licenses for 150, 300 and 600 pages are expected to expire within 24 to 26 weeks.

At step S114, the customer is offered a new license, such as for example, by displaying a message at the user interface 28 of imaging apparatus 12, and/or at the display monitor of host 14.

At step S116, it is determined whether the customer wants to purchase a new license. This determination may be made, for example, by controller 34 or host 14 based on input received from the customer, such as via user interface 28 of imaging apparatus 12 or a keyboard of host 14. If the determination is NO, then the process proceeds to step S118, and then the process is ended for the current supply item.

If at step S116 the determination is YES, then at step S120 the customer purchases a new license via license vendor 16, which may be, for example, an e-commerce transaction. In the present embodiment, the license replenishment process is accomplished through an electronic means whereby imaging apparatus 12, or alternatively host 14, contacts license vendor 16 through an electronic network, such as for example, the Internet. Once contact is made with license vendor 16, the customer will be required to perform an e-commerce transaction. After license vendor 16 verifies the e-commerce transaction is successful, license vendor 16 will send the printer a license, e.g., license identification and associated license amount, by a secure electronic transmission, such as those known in the art, or by using one of the security measures more fully described below.

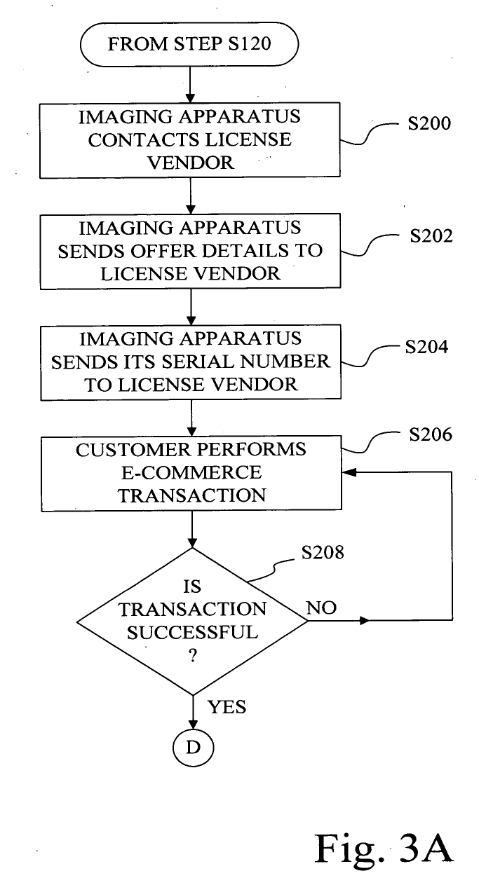

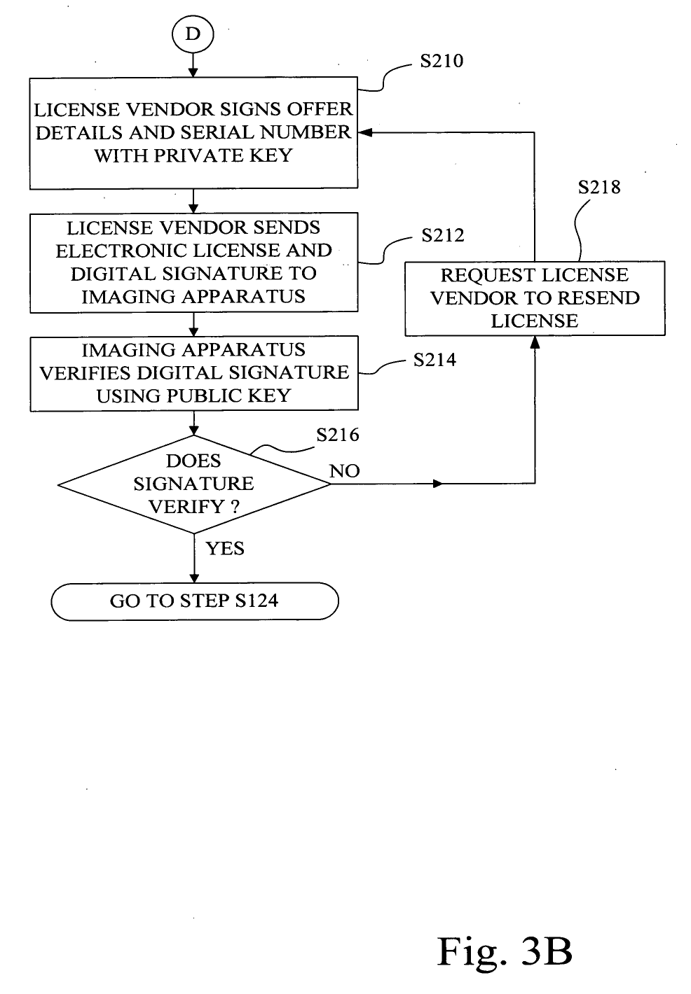

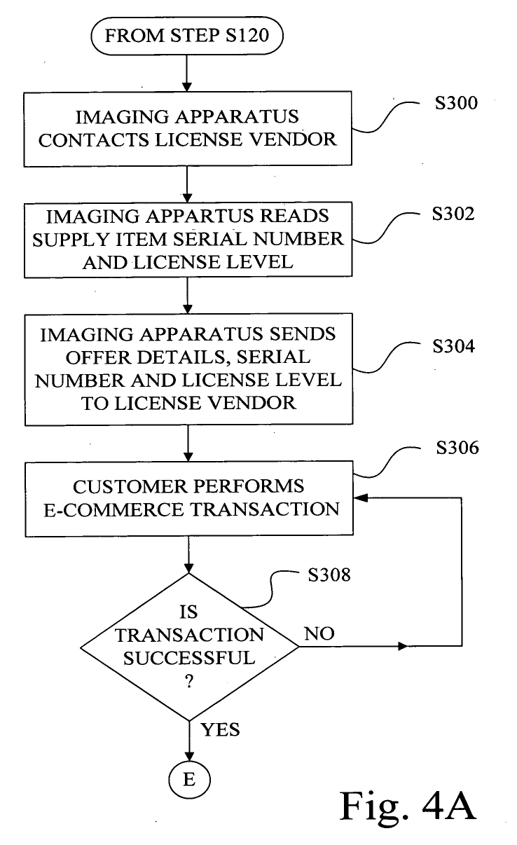

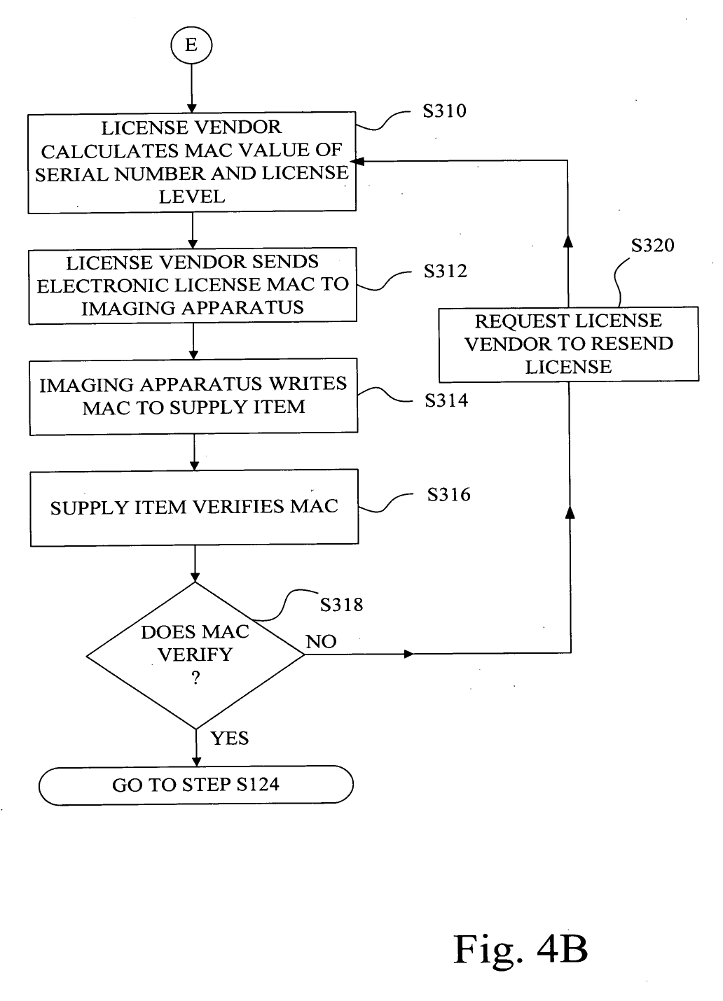

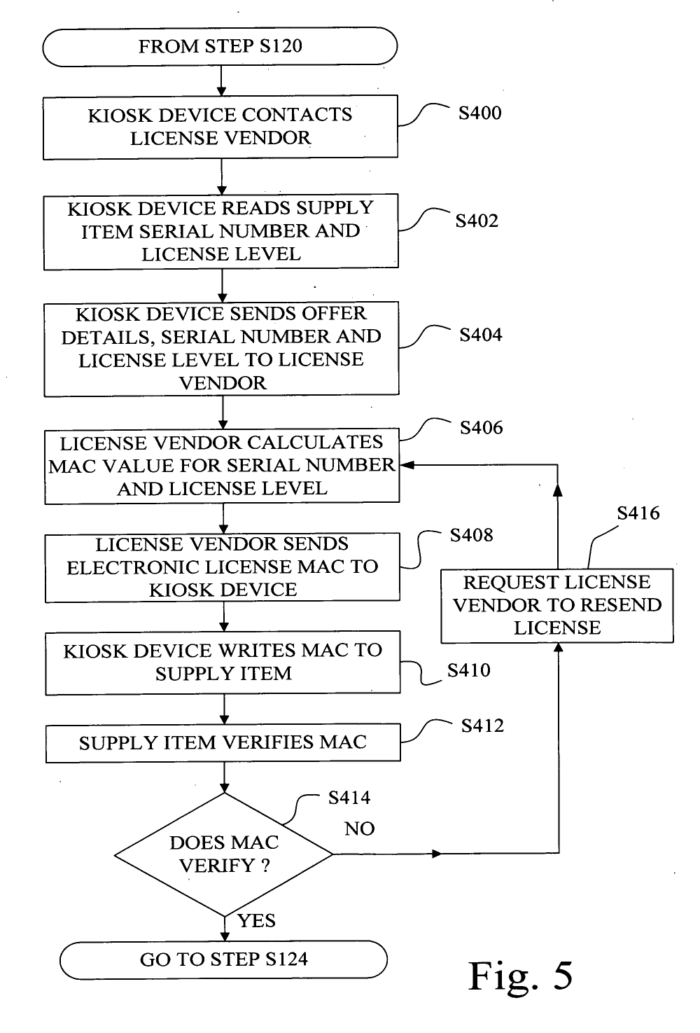

At step S122, a security system verifies the new license as valid. The security system may be incorporated, for example, into license monitoring mechanism 48. Once verified, printing is resumed at step S124, and the process returns to usage rate monitoring at step S104. The security measures performed at step S122 will be described in more detail below with respect to the embodiments of FIGS. 3A, 3B; FIGS. 4A, 4B; and FIG. 5.

Once the second license is depleted, if there is enough imaging substance in supply item 32 to accommodate an additional license, the customer will again be offered a new license. The amount and cost of the third license (second new license) will again be a function of the usage rate of the first and second licenses. This licensing process may be repeated as long as there is imaging substance available in supply item 32. Once the imaging substance is depleted, as determined at step S108, the customer will be informed at step S118 to replace the current supply item with a new supply item.

Optionally, if the manufacturer decides to license the entire contents of supply item 32 in the first license, then the customer may be directed to purchase a new supply item based on the customer's supply item usage rate. For example, a high usage customer may be directed to purchase a high yield cartridge, or a low yield cartridge if they prefer a lower acquisition cost, whereas a low usage customer will be directed to purchase a low yield cartridge.

The security measures of step S122 may be dependent upon the object to which the license is attached, i.e., imaging apparatus 12 or supply item 32. The first security method described below (see the embodiment of FIGS. 3A-3B) is for a system in which the license will remain with imaging apparatus 12. The second security method described below (see the embodiments of FIGS. 4A, 4B and 5) is for a system in which the electronic license is sold with supply item 32.

Referring to FIGS. 1 and 3A, 3B, imaging apparatus 12 may be sold with supply item 32 filled with imaging substance. The security of the first method may utilize a Public/Private Key security. Controller 34 of imaging apparatus 12 will contain the Public Key of license vendor 16, along with a unique serial number that identifies imaging apparatus 12. License vendor 16, e.g., a server, will contain the corresponding Private Key.

At step S200, imaging apparatus 12 contacts license vendor 16. At step S202, imaging apparatus 12 sends the details of the license offer to license vendor 12. At step S204, imaging apparatus 12 sends a unique serial number of imaging apparatus 12 to license vendor 16 so that imaging apparatus 12 can be identified by license vendor 16.

At step S206, the customer conducts an e-commerce transaction to pay for the new license, e.g., via a credit card.

At step S208, it is determined whether the e-commerce transaction was successful. If the determination at step S208 is NO, then step S206 is repeated.

If the determination at step S208 is YES, then at step S210 license vendor 16 signs the offer details and serial number with the Private Key of license vendor 16.

At step S212, license vendor 16 sends an electronic license specific to the unique serial number that is digitally signed by the Private Key of license vendor 16.

At step S214, controller 34 of imaging apparatus 12 receives this license, and controller 34 verifies the authenticity of the license by using the Public Key of license vendor 16 to verify the digital signature.

At step S216, controller 34 of imaging apparatus 12 determines whether the signature verifies. If the determination is YES, i.e., that electronic license is verified, then imaging apparatus 12 will allow the customer to begin using the new license, and the process continues at step S124 of FIG. 2B.

If the determination at step S216 is NO, then at step S218 license vendor 16 is requested to resend the license, and the process continues at step S210.

FIGS. 4A, 4B, and FIG. 5, are flowcharts depicting two embodiments, respectively, of the above-referenced second security method, wherein supply item 32 will contain the license. This will allow supply item 32 to be moved to a different imaging apparatus while utilizing the same license. In addition, multiple numbers of licenses can be contained in a single supply item. The license can be replenished by imaging apparatus 12 or by another device that has the capability of communicating with supply item 32, e.g., a kiosk in a retail store.

This method is implemented by storing a set of message authentication codes (MACs), in the electronic electronics module 46 of the supply item 32 during the manufacturing of supply item 32. The MACs may be derived, for example, from the unique serial number of the supply item 32 by utilizing the FIPS standard HMAC (keyed-hashing for message authentication) algorithm. Each MAC stored in electronics module 46 will represent a license that may be used by supply item 32. In order to utilize the license, the correct MAC code corresponding to the license level is written to electronics module 46 of supply item 32. When the MAC is written by imaging apparatus 12, or by another device (such as a device at a kiosk), the ASIC in electronics module 46 of supply item 32 will compare the MAC written to the MAC stored during manufacturing, and if they are equal then supply item 32 will allow the next license to be used.

This method, wherein supply item is installed in imaging apparatus 12, will now be described with respect to the flowchart of FIGS. 4A and 4B.

At step S300, imaging apparatus 12 contacts license vendor 16.

At step S302, imaging apparatus 12 reads the serial number and license level (e.g., first license, second license, etc.) from electronics module 46 of supply item 32.

At step S304, imaging apparatus 12 sends the details of the license offer, the serial number of supply item 32 and the license level to license vendor 16.

At step S306, the customer conducts an e-commerce transaction to pay for the new license, e.g., via a credit card.

At step S308, it is determined whether the e-commerce transaction was successful. If the determination at step S308 is NO, then step S306 is repeated.

If the determination at step S308 is YES, then at step S310 license vendor 16 calculates a MAC value based on the serial number of supply item 32 and the license level.

At step S312, license vendor 16 sends an electronic license MAC to imaging apparatus 12.

At step S314, controller 34 of imaging apparatus 12 writes the license MAC to electronics module 46 of supply item 32.

At step S316, electronics module 46 of supply item 32 verifies the license MAC.

At step S318, electronics module 46 of supply item 32 determines whether the MAC verifies. If the determination is YES, i.e., that electronic license is verified, then imaging apparatus 12 will allow the customer to begin using the new license, and the process continues at step S124 of FIG. 2B.

If the determination at step S318 is NO, then at step S320 license vendor 16 is requested to resend the license MAC, and the process continues at step S310.

A method wherein supply item 32 is installed in device at a kiosk will now be described with respect to the flowchart of FIG. 5. For replenishment by a kiosk system, the customer will take supply item 32 that can be licensed to a kiosk, such as those found in a retail store. If there is enough imaging substance remaining in supply item 32 for another license, then the kiosk will make the customer an offering, in the manner previous described, based on the usage rate of the previous license. If the customer decides on purchasing a new license, the kiosk operator will place supply item 32 in an electronic device that has the capability to communicate with electronics module 46 of supply item 32.

At step S400, the kiosk device contacts license vendor 16.

At step S402, the kiosk device reads the serial number and license level (e.g., first license, second license, etc.) from electronics module 46 of supply item 32.

At step S404, the kiosk device sends the details of the license offer, the serial number of supply item 32 and the license level to license vendor 16.

At step S406 license vendor 16 calculates a MAC value based on the serial number of supply item 32 and the license level.

At step S408, license vendor 16 sends an electronic license MAC to the kiosk device.

At step S410, the kiosk device writes the license MAC to electronics module 46 of supply item 32.

At step S412, electronics module 46 of supply item 32 verifies the license MAC.

At step S414, electronics module 46 of supply item 32 determines whether the MAC verifies. If the determination is YES, i.e., that electronic license is verified, then electronics module 46 of supply item 32 will allow the customer to begin using the new license, and the process continues at step S124 of FIG. 2B.

If the determination at step S414 is NO, then at step S416 license vendor 16 is requested to resend the license MAC, and the process continues at step S406.

Thus, with the security methods described above, a new license can be established by imaging apparatus 12, or by a kiosk device. From the customer's perspective, however, the license replenishment will appear the same as the method discussed previously with respect to FIGS. 3A, 3B utilizing Public/Private Key security.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for reducing a cost of imaging to a customer, comprising:
determining a rate of consumption of imaging substance from a supply item; and,
based on said rate of consumption, offering to said customer an imaging reward.

2. The method of claim 1, wherein each imaging reward of a plurality of imaging rewards comprises an opportunity to acquire access to a respective amount of imaging substance in said supply item for a respective fixed fee.

3. The method of claim 2, wherein the fixed fee for at least one of the imaging rewards is lower than the fixed fee for at least one of the other imaging rewards.

4. The method of claim 2, wherein one of the imaging rewards associated with a relatively lower fixed fee is associated with a projected cost per page that is higher than a projected cost per page associated with one of the imaging rewards associated with a relatively higher fixed fee.

5. The method of claim 1, wherein said imaging reward is a new license having associated therewith a cost and an amount of imaging substance in said supply item, wherein at least one of said cost and said amount of imaging substance is determined based on a rate of consumption of imaging substance during a previous license.

6. The method of claim 5, wherein security measures are performed to verify the validity of said new license.

7. The method of claim 6, wherein said security measures include:
a licensing vendor signing a license offer with a digital signature based on a serial number of an imaging apparatus and a private key; and
verifying said digital signature by said imaging apparatus using a public key.

8. The method of claim 6, wherein said security measures include:
a licensing vendor generating a license message authentication code (MAC) based on a serial number of said supply item; and
verifying said license MAC using an electronic module of said supply item.

9. The method of claim 8, wherein said supply item is installed in said imaging apparatus, said imaging apparatus facilitating communication with said licensing vendor.

10. The method of claim 8, wherein said supply item is installed in a kiosk device, said kiosk device being in communication with said licensing vendor.

11. The method of claim 1, wherein a plurality of imaging rewards are offered to said customer based on said rate of consumption.

12. The method of claim 11, wherein said customer selects one of said plurality of imaging rewards.

13. The method of claim 1, wherein said rate of consumption is based on one of: an amount of time required to use a specified amount of said supply item; an amount of time between acquisitions of the supply item; an amount of use of said supply item during a specified amount of time; an amount of imaging substance volume acquired during a specified amount of time; and a quantity of supply items acquired during a specified amount of time.

14. A supply item for use in an imaging apparatus, the supply item being associated with memory for storing information upon which a rate of consumption of imaging substance from said supply item can be determined, wherein at least one of a cost and an amount of imaging substance associated with an imaging reward is based on said rate of consumption.

15. The supply item of claim 14, wherein said imaging reward is a new license for said supply item, and wherein at least one of a cost and an amount of imaging substance associated with said new license is determined based on a rate of consumption of imaging substance during a previous license.

16. The supply item of claim 15, including an electronics module for verifying said new license by verifying a message authentication code (MAC) generated by an external device based on a serial number of said supply item.

17. A method for reducing a cost of imaging to a customer, comprising:
determining a rate of consumption of imaging substance from a supply item during a current license, wherein an amount of said imaging substance in said supply item is more than will be consumed during said current license; and,
based on said rate of consumption during said current license, offering to said customer a new license for at least a portion of a remainder of said amount of imaging substance.

18. The method of claim 17, wherein each license of a plurality of new licenses comprises an opportunity to acquire access to a respective amount of imaging substance in said supply item for a respective fixed fee.

19. The method of claim 18, wherein the fixed fee for at least one of the licenses is lower than the fixed fee for at least one of the other licenses.

20. The method of claim 18, wherein one of the licenses associated with a relatively lower fixed fee is associated with a projected cost per page that is higher than a projected cost per page associated with one of the licenses associated with a relatively higher fixed fee.
